(19) United States
(12) Patent Application Publication
(10) Pub. No.: US 2017/0229796 A1
(43) Pub. Date: Aug. 10, 2017

(54) GROUND CONNECTION STRUCTURE AND GROUND TERMINAL FITTING

(71) Applicant: Sumitomo Wiring Systems, Ltd., Yokkaichi (JP)

(72) Inventor: Yuji Kitagawa, Yokkaichi (JP)

(21) Appl. No.: 15/408,954

(22) Filed: Jan. 18, 2017

(30) Foreign Application Priority Data
Feb. 8, 2016 (JP) 2016-021560

(51) Int. Cl. H01R 4/64; H01R 4/30; H01R 11/12; H01R 4/34

(52) U.S. Cl. CPC H01R 4/64; H01R 4/34; H01R 4/305; H01R 11/12; H01R 2201/26

(57) ABSTRACT

A ground connection structure includes a ground terminal fitting (20) with a bolt hole (28). Resilient locking pieces (29) are formed on an inner peripheral edge of the bolt hole (28) and are locked to an externally threaded portion (13) of a stud bolt (12). A rotation stopping portion (31) is formed on the ground terminal fitting (20) and is locked to a rotation stopping hole (14) of a plate-like ground member (10). A resilient retaining piece (32) is formed on the rotation stopping portion (31) and is configured to restrict separation of the rotation stopping portion (31) from the rotation stopping hole (14) by locking to an edge part of the rotation stopping hole (14).

### BACKGROUND

1. Field of the Invention

The invention relates to a ground connection structure and a ground terminal fitting.

2. Description of the Related Art

Japanese Unexamined Patent Publication No. 2010-198856 discloses a ground connection structure with a ground terminal that has an insertion hole fit to a stud bolt standing on a body panel. An engaging claw is formed in the insertion hole and engages a screw groove of the stud bolt. According to this structure, the ground terminal can be held temporarily on the body panel without using a nut or other such fastening means.

The engaging claw in the above temporary holding structure easily can disengage from the screw groove of the stud bolt. Thus, the ground terminal may come off the stud bolt by its own weight if the body panel is inclined in an overhanging manner and the stud bolt is projecting obliquely down.

The invention was completed based on the above situation and aims to enable a ground terminal fitting to be held temporarily held on a plate-like ground member in a reliable manner.

### SUMMARY

The invention relates to a ground connection structure with a plate-like ground member, and a rotation stopping hole penetrates through the plate-like ground member. A stud bolt projects from a ground surface of the plate-like ground member, and a ground terminal fitting is to be connected conductively to the plate-like ground member while being held in contact with the ground surface. A bolt hole is formed in the ground terminal fitting and allows the passage of the stud bolt therethrough, and a nut is configured to be screwed onto an externally threaded portion of the stud bolt so that the ground terminal fitting is sandwiched between the ground surface and the nut. A resilient locking piece projects from an inner peripheral edge of the bolt hole and is resiliently lockable to the externally threaded portion. A rotation stopping portion is formed on the ground terminal fitting and is lockable to the rotation stopping hole when the stud bolt is passed through the bolt hole. A resilient retaining piece is formed on the rotation stopping portion and is configured to lock an edge of the rotation stopping hole to restrict separation of the rotation stopping portion from the rotation stopping hole.

The invention also relates to a ground terminal fitting to be connected conductively to a ground surface of a plate-like ground member. A stud bolt projects from the ground surface of a plate-like ground member, and the ground terminal fitting includes a bolt hole that allows passage of the stud bolt therethrough. The ground terminal fitting can be sandwiched between the ground surface and a nut screwed onto an externally threaded portion of the stud bolt. A resilient locking piece projects from an inner peripheral edge of the bolt hole and is resiliently lockable to the externally threaded portion of the stud bolt. A rotation stopping portion is formed on the ground terminal fitting and is lockable to a rotation stopping hole. A resilient retaining piece is formed on the rotation stopping portion and is configured to restrict separation of the rotation stopping portion from the rotation stopping hole by being locked to an edge of the rotation stopping hole.

The ground terminal fitting reliably is held temporarily on the plate-like ground member by locking at two different positions, namely, by locking the resilient locking piece to the externally threaded portion of the stud bolt and locking the resilient retaining piece to the edge of the rotation stopping hole.

The rotation stopping portion may be a flat plate substantially parallel to a penetrating direction of the rotation stopping hole in the plate-like ground member. Thus, operability is good since a locked state is achieved merely by inserting the rotation stopping portion straight into the rotation stopping hole.

A projecting dimension of the rotation stopping portion may be smaller than the projecting dimension of the stud bolt in an axial direction of the stud bolt. According to this configuration, the rotation stopping portion can be inserted into the rotation stopping hole after the bolt hole is fit to the stud bolt. Thus, operability is better than the case where the fitting of the bolt hole and the insertion of the rotation stopping portion are performed simultaneously.

The ground terminal fitting may include a terminal body in the form of a flat plate formed with the bolt hole and capable of contacting the nut. The resilient locking piece may project obliquely from the terminal body toward a projecting end of the stud bolt, and a seating surface of the nut may be formed with an accommodating recess capable of accommodating the resilient locking piece. According to this configuration, the resilient locking piece does not butt against the externally threaded portion in the process of fitting the bolt hole to the stud bolt while resiliently bringing the resilient locking piece into contact with the externally threaded portion of the stud bolt. Thus, fitting operability to the stud bolt is good. Further, the resilient locking piece that projects toward the projecting end of the stud bolt may interfere with the seating surface of the nut. However, the seating surface is formed with the accommodating recess that can accommodate the resilient locking piece. Thus, the terminal body portion can be reliably sandwiched between the ground surface and the nut.

### BRIEF DESCRIPTION OF THE DRAWINGS

FIG. 1 is a section of a ground connection structure of one embodiment.

FIG. 2 is a front view of a ground terminal fitting.

### DETAILED DESCRIPTION

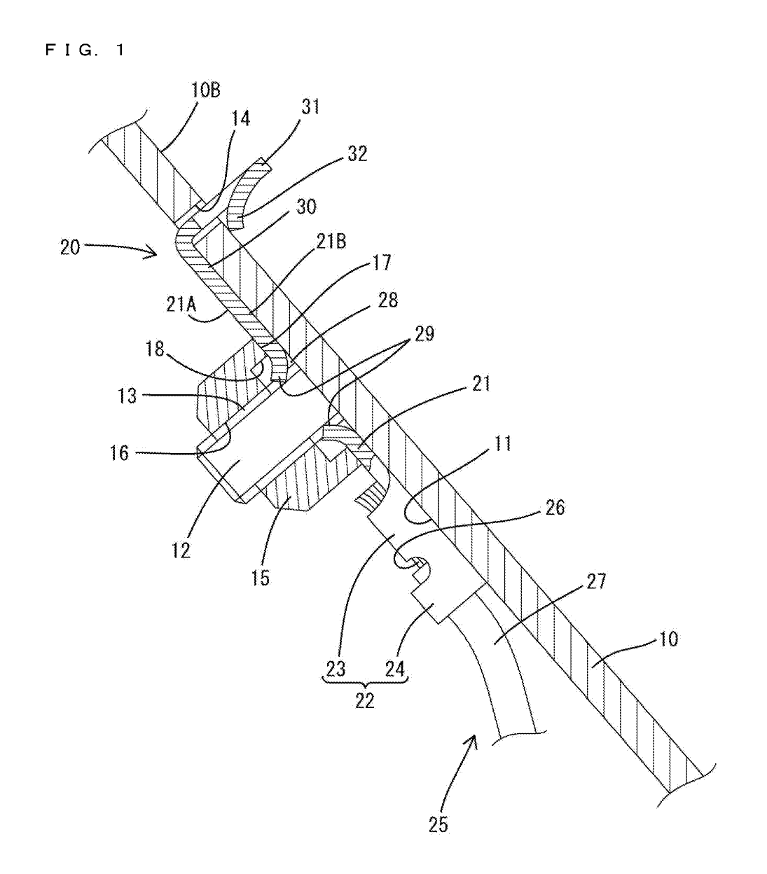

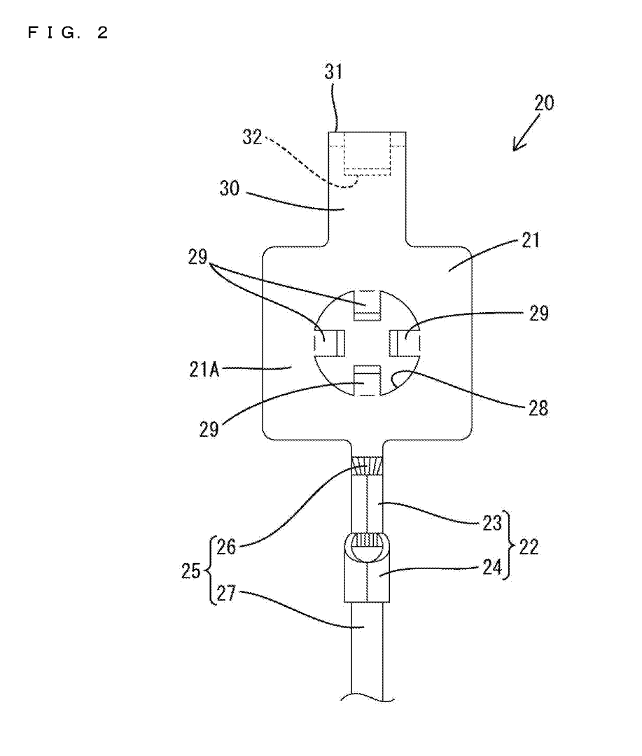

One embodiment of the invention is described with reference to FIGS. 1 and 2. Note that, in the following description, sides shown in FIGS. 1 and 2 are defined as a front-back direction and a vertical direction. Left and right sides shown in FIG. 2 are defined as left and right sides concerning a lateral direction.

A ground connection structure of this embodiment includes a plate-like ground member 10 that is part of a body of an automotive vehicle. A stud bolt 12 projects from a ground surface 11 of the plate-like ground member 10, and a nut 15 is to be screwed onto the stud bolt 12. A ground terminal fitting 20 is to be connected to the ground surface 11 of the plate-like ground member. The ground surface 11 of the plate-like ground member 10 is substantially flat and faces obliquely down so that the ground surface 11 is inclined in an overhanging manner.

A rotation stopping hole 14 penetrates the plate-like ground member 10 in a plate thickness direction. The stud bolt 12 is arranged below the rotation stopping hole 14 on the ground surface 11 and projects obliquely down with an axis substantially at a right angle to the ground surface 11. An externally threaded portion 13 is formed on the outer periphery of the stud bolt 12.

An internally threaded hole 16 penetrates through a center of the nut 15 and is to be screwed onto the externally threaded portion 13 of the stud bolt 12 so that a seating surface 17 of the nut 15 faces the ground surface 11. The seating surface 17 of the nut 15 is formed with a circular accommodating recess 18 at the edge of the internally threaded hole 16. The accommodating recess 18 is concentric with the internally threaded hole 16 and communicates with the internally threaded hole 16. An inner diameter of the accommodating recess 18 is larger than an outer diameter of the stud bolt 12.

The ground terminal fitting 20 is formed by applying bending and the like to a metal plate material of a predetermined shape. The ground terminal fitting 20 is a single component including a terminal body 12, a crimping portion 22 and a rotation stopping portion 31. The terminal body 21 is a flat plate having a substantially square shape in a front view and comes into surface contact with the ground surface 11.

The crimping portion 22 extends down from the lower end edge of the terminal body 21. The crimping portion 22 is composed of a wire barrel 23 and an insulation barrel 24 connected to and below the wire barrel 23. The wire barrel 23 is crimped conductively to a core 26 exposed in an upper end part of a coated wire 25. The insulation barrel 24 is crimped to an insulation coating 27 in the upper end part of the coated wire 25.

A bolt hole 28 penetrates through a center of the terminal body 21 in a plate thickness direction and is circular in front view. An inner diameter of the bolt hole 28 is larger than the outer diameter of the stud bolt 12 and smaller than the inner diameter of the accommodating recess 18.

The terminal body 21 is formed with four resilient locking pieces 29 cantilevered in from an edge of the bolt hole 28. The four resilient locking pieces 29 have common shapes and dimensions and are arranged at equal angular intervals of 90° in a circumferential direction. Each resilient locking piece 29 is resiliently displaceable relative to the terminal body 21.

Each resilient locking piece 29 projects radially inward in a front view, and a diameter of a virtual circle (not shown) inscribing the projecting ends of the four resilient locking pieces 29 is smaller than the outer diameter of the stud bolt 12. Each resilient locking piece 29 projects obliquely toward the side of a surface 21A of the terminal body 21 when viewed parallel to the terminal body 21. The surface 21A of the terminal body 21 achieves surface contact with the seating surface 17 of the nut 15 when the ground terminal fitting 20 is connected to the plate-like ground member 10.

The terminal body 21 is formed with a base plate 30 cantilevered up from the upper edge thereof. A substantially flat plate-shaped rotation stopping portion 31 projects substantially perpendicularly from the upper projecting end edge of the base plate 30 toward the underside 21B of the terminal body 21. The underside 21B of the terminal body 21 is brought into surface contact with the ground surface 11 when the ground terminal fitting 20 is connected to the plate-like ground member 10.

A part of the rotation stopping portion 31 is cut and raised to form a resilient retaining piece 32. The resilient retaining piece 32 projects from a projecting end side of the rotation stopping portion 31 toward a lower surface of the base plate 30 and is cantilevered obliquely with respect to the rotation stopping portion 31 in a direction toward the bolt hole 28 and the stud bolt 12. An interval between the base plate 30 and the projecting end of the resilient retaining piece 32 in the plate thickness direction of the terminal body 21 is substantially equal to a plate thickness of the plate-like ground member 10. Further, a projecting dimension of the rotation stopping portion 31 from the underside 21B of the terminal body 21 (base plate 30) is smaller than that of the stud bolt 12 from the ground surface 11.

Before the nut 15 is screwed onto the stud bolt 12, the bolt hole 28 of the ground terminal fitting 20 is fit to the projecting end part of the stud bolt 12 with the terminal body 21 facing substantially parallel to the ground surface 11. At this time, the projecting end of the rotation stopping portion 31 has yet to reach the ground surface 11. When the bolt hole 28 is fit to the stud bolt 12, the four resilient locking pieces 29 are locked to a groove (not shown) of the externally threaded portion 13 while being resiliently deformed.

The ground terminal fitting 20 is brought closer to the ground surface 11 from this state so that the bolt hole 28 is displaced toward the base end of the stud bolt 12 and the resilient locking pieces 29 move over a crest (not shown) of the externally threaded portion 13 while being resiliently deformed. The resilient locking pieces 29 project toward the projecting end of the stud bolt 12 (i.e. in a direction opposite to a moving direction of the terminal body 21) in an axial direction of the stud bolt 12. Thus, the projecting ends of the resilient locking pieces 29 do not butt against the groove of the externally threaded portion 13 to be hooked.

The rotation stopping portion 31 approaches the ground surface 11 as the ground terminal fitting 20 is brought closer to the ground surface 11. Thus, the terminal body 21 is rotated about the stud bolt 12 and the rotation stopping portion 31 is aligned to the rotation stopping hole 14. The ground terminal fitting 20 is brought closer to the ground surface 11 after the alignment, and the rotation stopping portion 31 enters the rotation stopping hole 14. An inserting direction at this time is substantially parallel to a projecting direction of the rotation stopping portion 31.

The resilient retaining piece 32 interferes with the edge of the rotation stopping hole 14 and deforms resiliently in the process of inserting the rotation stopping portion 31 into the rotation stopping hole 14. The ground terminal fitting 20 is in a positional relationship with the plate-like ground member 10 corresponding to a properly connected state when the terminal body 21 and the base plate 30 come into surface contact with the ground surface 11. At this time, the four resilient locking pieces 29 are locked resiliently to the externally threaded portion 13. This resilient locking action restricts a displacement of a part of the terminal body 21 near the bolt hole 28 away from the ground surface 11.

The resilient retaining piece 32 passes completely over the rotation stopping hole 14 when the terminal body 21 and the base plate 30 come into surface contact with the ground surface 11. Thus, the resilient retaining piece 32 resiliently returns. The projecting end of the resiliently returned resilient retaining piece 32 is locked to butt against the edge of the rotation stopping hole 14 on the underside 10B (surface opposite to the ground surface 11) of the plate-like ground member 10. This locking restricts a displacement of the rotation stopping portion 31 in a direction to come out of the rotation stopping hole 14 and restricts a displacement of the rotation stopping portion 31 in a direction away from the ground surface 11.

As just described, the locking action by the resilient locking pieces 29 in the bolt hole 28 and the locking action by the resilient retaining piece 32 in the rotation stopping portion 31 holds the ground terminal fitting 20 temporarily in the same positional relationship with the ground surface 11 (plate-like ground member 10) as in the properly connected state. The ground surface 11 is a downwardly oblique and overhanging surface. Thus, the ground terminal fitting 20 may fall down by its own weight. However, the ground terminal fitting 20 is locked to the plate-like ground member 10 at two vertically spaced positions so that the ground terminal fitting 20 reliably is held temporarily on the plate-like ground member 10 without falling down.

The nut 15 is screwed onto the stud bolt 12 after the ground terminal fitting 20 is held temporarily on the ground surface 11. The seating surface 17 of the nut 15 comes into surface contact with the surface 21A of the terminal body 21 as the nut 15 is screwed to the base end of the stud bolt 12. The nut 15 is tightened with a predetermined torque and presses the terminal body 21 against the ground surface 11. Thus, the terminal body 21 is sandwiched between the nut 15 and the ground surface 11. Note that the ground terminal fitting 20 does not rotate together with the nut 15 because the rotation stopping portion 31 is locked to the rotation stopping hole 14 when the nut 15 is tightened. In this way, the terminal body 21 of the ground terminal fitting 20 reliably is connected conductively to the ground surface 11 of the plate-like ground member 10.

This ground connection structure includes the plate-like ground member 10 formed with the rotation stopping hole 14, the stud bolt 12 projecting from the ground surface 11 of the plate-like ground member 10, the ground terminal fitting 20 to be connected conductively to the plate-like ground member 10 while being held in contact with the ground surface 11, and the nut 15 configured to sandwich the ground terminal fitting 20 between the ground surface 11 and the nut 15 by being screwed onto the externally threaded portion 13 of the stud bolt 12.

The ground terminal fitting 20 is formed with the bolt hole 28 allowing the passage of the stud bolt 12 therethrough. The resilient locking pieces 29 project from the inner peripheral edge of the bolt hole 28 and resiliently lock to the externally threaded portion 13. Further, the ground terminal fitting 20 is formed with the rotation stopping portion 31 that is lockable to the rotation stopping hole 14 when the stud bolt 12 is passed through the bolt hole 28. The rotation stopping portion 31 is formed with the resilient retaining piece 32 that is configured to restrict separation of the rotation stopping portion 31 from the rotation stopping hole 14 by being locked to the edge of the rotation stopping hole 14. According to this configuration, when the resilient locking pieces 29 are locked to the screw groove of the stud bolt 12 and the resilient retaining piece 32 is locked to the edge of the rotation stopping hole 14, the ground terminal fitting 20 can be held reliably on the plate-like ground member 10 by locking means at two different positions.

The rotation stopping portion 31 is a flat plate substantially parallel to a penetrating direction of the rotation stopping hole 14 in the plate-like ground member 10. Thus, a locked state is reached merely by inserting the rotation stopping portion 31 straight into the rotation stopping hole 14 so that operability is good.

The projecting dimension of the rotation stopping portion 31 from the underside 21B of the terminal body 21 is less than that of the stud bolt 12 from the ground surface 11 in the axial direction of the stud bolt 12. Accordingly, the rotation stopping portion 31 can be inserted into the rotation stopping hole 14 after the bolt hole 28 is fit to the stud bolt 12. Thus, operability is better than if the fitting of the bolt hole 28 to the stud bolt 12 and the insertion of the rotation stopping portion 31 into the rotation stopping hole 14 are performed simultaneously.

The ground terminal fitting 20 includes the flat plate-shaped terminal body portion 21 that is capable of contacting the nut 15 and that is formed with the bolt hole 28. The seating surface 17 of the nut 15 comes into contact with the surface 21A of the terminal body 21. The resilient locking pieces 29 project obliquely toward the projecting end of the stud bolt 12 from the terminal body portion 21 and the seating surface 17 of the nut 15 is formed with the accommodating recess 18 capable of accommodating the resilient locking pieces 29.

According to this configuration, the resilient locking pieces 29 do not butt against the externally threaded portion 13 in the process of fitting the bolt hole 28 to the stud bolt 12 while resiliently bringing the resilient locking pieces 29 into contact with the externally threaded portion 13 of the stud bolt 12. Thus, fitting operability to the stud bolt 12 is good. Resilient locking pieces 29 that project toward the projecting end of the stud bolt 12 may interfere with the seating surface 17 of the nut 15. However, the seating surface 17 is formed with the accommodating recess 18 capable of accommodating the resilient locking pieces 29. Thus, the seating surface 17 of the nut 15 can be brought reliably into contact with the surface 21A of the terminal body 21 and the terminal body 21 can be sandwiched reliably between the ground surface 11 and the nut 15.

The invention is not limited to the above described and illustrated embodiment. For example, the following embodiments are also included in the scope of the invention.

The rotation stopping portion is a flat plate substantially parallel to the penetrating direction of the rotation stopping hole in the above embodiment. However, the rotation stopping portion may be bent in a stepped manner.

Plural resilient locking pieces are formed in the above embodiment, but only one resilient locking piece may be formed.

The resilient retaining piece projects toward the lower side of the rotation stopping portion in the above embodiment, but may project toward the upper side of the rotation stopping portion.

The rotation stopping portion is above the bolt hole with the ground terminal fitting connected to the plate-like ground member in the above embodiment. However, the rotation stopping portion may be below the bolt hole or at the same height position as the bolt hole.

The projecting dimension of the rotation stopping portion is smaller than that of the stud bolt in the axial direction of the stud bolt in the above embodiment. However, the projecting dimension of the rotation stopping portion may be larger than that of the stud bolt or the projecting dimension of the rotation stopping portion and that of the stud bolt may be equal.

Although the resilient locking pieces project toward the projecting end of the stud bolt in the above embodiment, the resilient locking pieces may project toward the ground surface side.

### LIST OF REFERENCE SIGNS

10 . . . plate-like ground member
11 . . . ground surface
12 . . . stud bolt
13 . . . externally threaded portion
14 . . . rotation stopping hole
15 . . . nut
17 . . . seating surface
18 . . . accommodating recess
20 . . . ground terminal fitting
21 . . . terminal body
28 . . . bolt hole
29 . . . resilient locking piece
31 . . . rotation stopping portion
32 . . . resilient retaining piece

What is claimed is:

1. A ground connection structure, comprising:
a plate-like ground member (10) with a ground surface (11) a rotation stopping hole (14) penetrating through the plate-like ground member (10);
a stud bolt (12) projecting from the ground surface (11);
a ground terminal fitting (20) conductively connected to the plate-like ground member (10) while being held in contact with the ground surface(11);
a bolt hole (28) formed in the ground terminal fitting (20) and allowing the passage of the stud bolt (12) therethrough;
a nut (15) sandwiching the ground terminal fitting (20) between the ground surface (11) and the nut (15) by being screwed onto an externally threaded portion (13) of the stud bolt (12);
a resilient locking piece (29) projecting from an inner peripheral edge of the bolt hole (28) and resiliently locking to the externally threaded portion (13);
a rotation stopping portion (31) formed on the ground terminal fitting (20) and lockable to the rotation stopping hole (14) with the stud bolt (12) passed through the bolt hole (28); and
a resilient retaining piece (32) formed on the rotation stopping portion (31) and configured to restrict the separation of the rotation stopping portion (31) from the rotation stopping hole (14) by being locked to an edge part of the rotation stopping hole (14).

2. The ground connection structure of claim 1, wherein the rotation stopping portion (31) is a flat plate substantially parallel to a penetrating direction of the rotation stopping hole (14) in the plate-like ground member (10).

3. The ground connection structure of claim 1, wherein a projecting dimension of the rotation stopping portion (31) is less than a projecting dimension of the stud bolt (12) in an axial direction of the stud bolt (12).

4. The ground connection structure of any one of claim 1, wherein:
the ground terminal fitting (20) includes a flat plate-shaped terminal body (21) contacting the nut (15) and formed with the bolt hole (28);
the resilient locking piece (29) projects obliquely from the terminal body (21) toward a projecting end of the stud bolt (12); and
a seating surface (17) of the nut (15) is formed with an accommodating recess (18) capable of accommodating the resilient locking piece (29).

5. A ground terminal fitting (20) conductively connectable to a ground surface (11) of a plate-like ground member (10) from which a stud bolt (12) projects, comprising:
a bolt hole (28) dimensioned and configured to allow passage of the stud bolt (12) therethrough;
a resilient locking piece (29) formed on an inner peripheral edge of the bolt hole (28) and to be locked to an externally threaded portion (13) of the stud bolt (12);
a rotation stopping portion (31) formed on the ground terminal fitting (20) and lockable to a rotation stopping hole (14) penetrating through the plate-like ground member (10); and
a resilient retaining piece (32) formed on the rotation stopping portion (31) and configured to restrict separation of the rotation stopping portion (31) from the rotation stopping hole (14) by being locked to an edge part of the rotation stopping hole (14).
